(19) United States
(12) Patent Application Publication
(10) Pub. No.: US 2012/0033177 A1
(43) Pub. Date: Feb. 9, 2012

(54) Aspheric, astigmatic, multi-focal contact lens with asymmetric point spread function

(76) Inventors: Edwin J. Sarver, Carbondale, IL (US); Donald R. Sanders, Elmhurst, IL (US)

(21) Appl. No.: 13/237,617

(22) Filed: Sep. 20, 2011

Related U.S. Application Data
(63) Continuation-in-part of application No. 11/924,296, filed on Oct. 25, 2007.
(60) Provisional application No. 60/862,992, filed on Oct. 26, 2006.

(51) Int. Cl. G02C 7/04

(52) U.S. Cl. 351/161

(57) ABSTRACT

Presbyopic contact lenses that provide improved vision quality by use of optical zones which are not symmetric about the lens optical axis. The contact lens includes an optic body sized and configured to be received in an eye (or eyes) of a presbyopic patient having a front surface with a front optical center and a back surface with a back optical center, and having a lens optical axis intersecting the front surface at the front optical center and the back surface at the back optical center, and having optical zones which are not symmetric about the lens optical axis. The lens construction produces an asymmetric point spread function which enables any resulting asymmetric stray light to be steered in a predetermined direction.

### CROSS REFERENCE TO RELATED APPLICATIONS

This application is a continuation-in-part of U.S. patent application Ser. No. 11/924,296, filed Oct. 25, 2007, which claims the benefit of the filing date of U.S. Provisional Patent Application No. 60/862,992, filed Oct. 26, 2006, the contents of which are herein incorporated by reference.

### FIELD OF THE INVENTION

The present invention relates to systems and methods for human vision correction, and in particular, to the correction of presbyopic eyes using contact lenses.

### BACKGROUND OF THE INVENTION

The normal human eye has two refracting elements: the cornea and the crystalline lens. For good vision, the powers and spacing of the cornea and crystalline lens and the distance between the crystalline lens and the retina must be such that the image of an object is brought into focus at the retina. If the powers of these refracting elements or the distances within the eye do not provide sharp focus at the retina, an optical correction to the eye must be made to provide the individual with sharp vision so a high quality of life can be maintained.

If the optics of the eye causes the focus to be in front of the retina, the eye is said to be myopic or near sighted. If the optics cause the focus to be behind the retina, the eye is said to be hyperopic or far sighted. Both myopic and hyperopic eyes are referred to as ametropic. If the optics cause a sharp focus at the retina, the eye is said to be emmetropic. For ametropic eyes, in addition to the optical system of the eye not being able to focus the light from a distant object onto the retina, the eye's focusing error may not be the same for each meridian of the eye. For example, the focusing error in the horizontal meridian could be −2 diopters (D), and in the vertical meridian it could be −4 D. In this case, the eye is said to have 2 D of astigmatism. The correction of this astigmatic error is often required to provide acceptable vision quality.

In the normal operation of the eye, the crystalline lens can alter its power through a combination of changing shape and changing location. This ability of the crystalline lens to change its power is called accommodation, and it allows an individual eye to focus on near or distant objects. As individuals reach middle age they begin to lose this ability to accommodate. This loss in the ability to accommodate is called presbyopia and is a natural consequence of aging.

Beyond these basic optical errors of defocus, astigmatism, and loss of accommodation, other aberrations can significantly affect vision quality. The amount of defocus that is present in a given meridian is usually dependent upon the distance an incident ray of light is from the center of the eye. In the human eye as incident optical rays enter the eye's pupil further from the center of the eye, they tend to experience more positive power causing them to shift more myopic compared to rays which enter closer to the center of the eye. This behavior of light rays as a function of their height in the pupil is referred to as spherical aberration and is typically the most important optical error beyond defocus and astigmatism in an eye.

The correction of defocus and astigmatism is commonly performed using either spectacle lenses or contact lenses. Less common, but increasing in popularity are corneal surgery corrections such as laser in situ keratomileusis (LASIK), photo refractive kerectomy (PRK), laser epithelial keratomileusis (LASIK), or implanting rings or other inlays in to the cornea.

The same optical corrections can be made using an intraocular lens (IOL). If the IOL is implanted with the crystalline lens still in the eye, it is called a phakic IOL (PIOL). If this PIOL is located in front of the iris it is referred to as an anterior chamber PIOL. If it is located behind the iris and in front of the crystalline lens, it is referred to as a posterior chamber PIOL. Defects in the eye such as cataracts, may require the crystalline lens to be removed and an IOL referred to as a pseudophakic IOL be put in its place.

One way to provide a presbyopic patient with the ability to focus on near and distance objects (and essentially restore a degree of accommodation) is to provide an optic with multiple focal regions such as is provided by a bi-focal spectacle lens. In a spectacle lens, this multi-focal ability is placed in different regions that the eye looks through. Typically, distance vision in the multi-focal spectacle is placed directly in front of the eye and near vision focus is placed lower in the lens so that the patient looks down to see close objects. In a contact lens, IOL, or presbyopic corneal surgery ablation plan, multi-focal regions are often placed in concentric regions. These concentric regions produce concentric zones of stray light surrounding focal points on the retina. Stray light such as this is often objectionable as it leads to lower contrast, glare and halos in a subject's vision.

Another alternative to correcting presbyopia is to correct one eye for distance vision and the other eye for near vision. This is called monovision and can be employed with contact lenses, corneal refractive surgery, or IOLs. The resulting vision is not satisfactory for most patients because one eye will have a blurry image for either distant or near objects.

Our goal is to describe a contact lens that corrects for defocus, astigmatism, and spherical aberration. In addition, the lens provides good vision quality over a range of object distances for presbyopic patients and does not suffer from the same level of reduced contrast, glare and halos that are visible in concentric zone multifocal corrections in contact lenses, IOLs, or corneal surgery ablation plans. This is accomplished by having regions which are not symmetric (or nearly symmetric) about the lens optical axis and steering the resulting asymmetric stray light in opposite directions (e.g. up and down or left and right) as the contact lens is placed into the left and right eyes. The brain's higher level vision processing will tend to cancel the stray light aberrations between the two views using binocular suppression and thus provide improved vision over traditional multi-focal contact lenses.

### SUMMARY OF THE INVENTION

The instant invention is related to presbyopic contact lenses that provide improved vision quality over a range of object distances. This is accomplished by having optical zones which are not symmetric (or nearly symmetric) about the lens optical axis and placing the contact lenses in the left and right eyes so that the asymmetric point spread functions are oriented in opposite directions.

In a particular embodiment, the invention relates to a contact lens, or a pair of such contact lenses for treatment of an eye, or eyes, of a presbyopic patient, and include an optic body sized and configured to be received in an eye (or eyes) of a presbyopic patient, said optic body including a front surface with a front optical center and a back surface with a back optical center, and having a lens optical axis intersecting the front surface at the front optical center and the back surface at the back optical center, and having optical zones which are not symmetric about the lens optical axis, wherein said lens construction produces an asymmetric point spread function which enables any resulting asymmetric stray light to be steered in a predetermined direction. When used for a pair of eyes, the lenses are constructed and arranged such that they include a left eye lens and a right eye lens, each lens having an optic body sized and configured to be received, respectively, in a left or right eye of a presbyopic patient, wherein each said lens construction produces an asymmetric point spread function which enables any resulting asymmetric stray light to be steered in a direction opposite to that of the other member of said pair of lenses, thereby enabling stray light aberrations to be canceled as a result of the patient's higher vision brain processing, and thereby providing improved vision over traditional multi-focal contact lenses.

It is an objective of the present invention to teach a contact lens design for a specific individual's eye, that is, optimized for physiological conditions (e.g., pupil diameter) and visual preferences (e.g., distance clarity verses near clarity).

It is another objective of the instant invention to provide a contact lens that may incorporate a correction for simple defocus and/or astigmatism.

These and other objectives and advantages of this invention will become apparent from the following description taken in conjunction with any accompanying drawings wherein are set forth, by way of illustration and example, contain embodiments of this invention. Any drawings contained herein constitute a part of this specification and include exemplary embodiments of the present invention and illustrate various objects and features thereof.

### BRIEF DESCRIPTION OF THE FIGURES

FIG. 1 illustrates the basic layout of the multi-focal contact lens;

FIG. 2 illustrates two radial focal regions of the front surface of the contact lens;

FIG. 3 illustrates the back optical zone of the contact lens to provide astigmatic correction;

FIG. 4 illustrates the ballast on the front surface of the contact lens used to orient the contact lens within the eye;

FIG. 5a illustrates a simplified ray tracing for a distant object through the bi-focal optic illustrated in FIG. 2; and

FIG. 5b illustrates a simplified ray tracing for a near object through the bi-focal optic illustrated in FIG. 2.

### DETAILED DESCRIPTION OF THE PREFERRED EMBODIMENT

Detailed embodiments of the instant invention are disclosed herein, however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

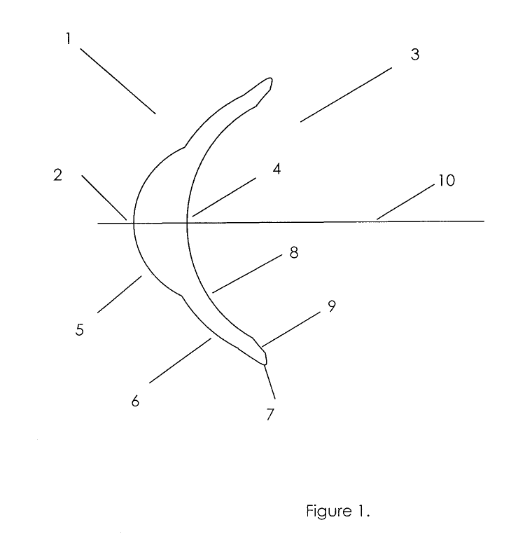

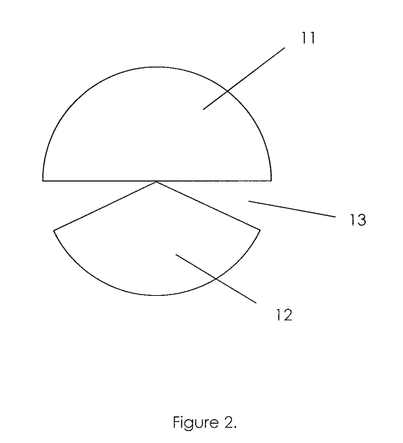

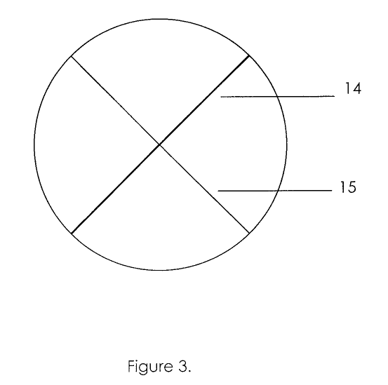

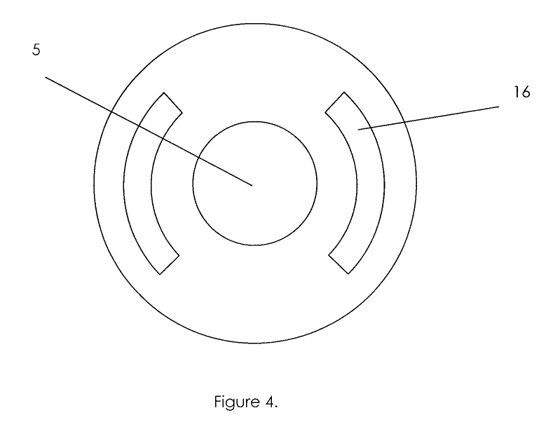

The preferred basic optical design of the contact lens is illustrated in FIGS. 1, 2, 3, and 4. FIG. 1 represents the basic structure of the contact lens. FIG. 2 represents the optical zone of the front surface of the contact lens to provide multi-focal correction. FIG. 3 represents the optical zone of the back surface of the contact lens to provide astigmatic correction. FIG. 4 illustrates optionally adding front surface ballast to orient a multi-focal or astigmatic contact lens.

As illustrated in FIG. 1, the front surface 1 of the contact lens has a front surface center point 2, a front optical zone 5, and a front peripheral zone 6. The back surface 3 of the contact lens has a back surface center point 4, a back surface central curvature 8, and a back surface peripheral curve 9. The edge 7 of the contact lens connects the front surface peripheral curve to the back surface peripheral curve. An optical axis 10 of the contact lens is a straight reference line that passes through the front and back surface center points.

As shown in FIG. 2, in the preferred embodiment the optical zone of the front surface has a wide superior sector 11 which provides a distance correction region, a less wide inferior sector 12 which provides a near correction region, and a blend region 13 that provides a smooth blend between the two focal correction regions. The ratio of areas of regions 11 and 12 can be varied to provide the desired fractions of area for distance and near vision correction based upon preferences of the contact lens wearer. If the contact lens is for a patient that does not yet need a presbyopic correction, the optical power of zones 11 and 12 are equal and the blend region 13 is equal to the radii used in zones 11 and 12. In addition to providing the desired focal power for the lens, the focal regions are also corrected for spherical aberration for the eye for the given focal distance. In this way, we allow for one spherical aberration correction value for distance vision correction and another spherical aberration correction value for near vision correction. The spherical aberration value can be selected to cancel spherical aberration in the patient's eye or can be selected to provide a continuous range of focal values to enhance the effect of pseudo-accommodation between the distance and near focal distances.

In FIG. 3, we illustrate that the back surface can contain two orthogonal principal curvatures 14 and 15 to provide an astigmatic correction. If no astigmatism correction is needed for a patient's eye, these principal curvatures are equal.

In FIG. 4 we illustrate that the front surface can contain a ballast to keep the contact lens oriented within the patient's eye. The ballast is blended into the front surface in the peripheral region. The blending is provided for comfort. The ballast works by being guided by the action of the top and bottom eye lids. As an alternative, a standard double slab-off ballast or prism ballast (known to those skilled in the art) may be used to orient the lens. The ballast is only required when the radial multifocal front optical zone or the astigmatic back surface is present in the contact lens. That is, for axi-symmetric contact lenses, no ballast is needed.

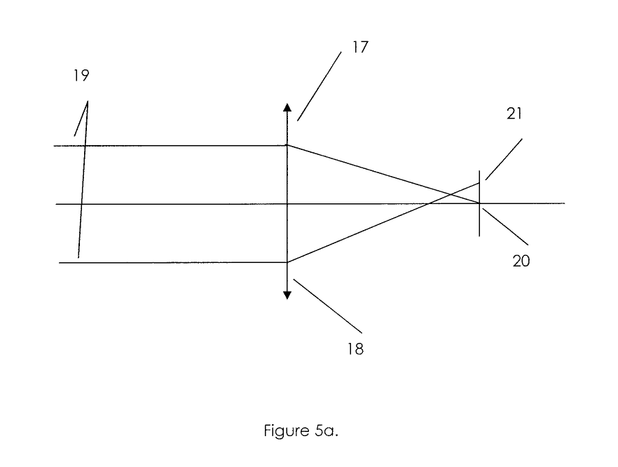

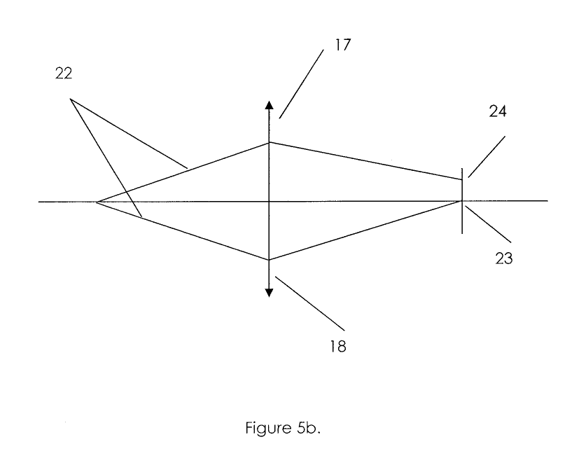

In FIGS. 5a and 5b we show a simplified ray tracing for distant and near objects through the bi-focal optic illustrated in FIG. 2. In FIG. 5a, the upper ray 19 from a distant object is refracted by distant focal region 17 and is brought into sharp focus at the center of the retina at point 20. In the same figure we show that the lower ray 19 from the same distant object is refracted by the more powerful near focal region 18 and, due to its additional power, forms a blur circle 21 above the optical axis. In FIG. 5b, the lower ray 22 from a near object is refracted by a near focal region 18 and brought into sharp focus at the center of the retina at point 23. The upper ray 22 from the near object is refracted by the less powerful distant focal region 17 and forms a blur circle 24 on the retina. Note that in both cases the stray light is located above the optical axis. This produces a non-symmetric point spread function for both near and distant objects. If we place the bi-focal optic as shown in FIG. 2 in the left eye and inverted in the right eye, we will have binocular images presented to the brain in which the stray light is directed in opposite directions. Through the process of binocular suppression the stray light will be reduced or eliminated by the brain and a clearer image will be perceived by the patient, thus enhancing the patient's vision for both near and distant objects.

The use of common optical design principles known to those skilled in the art of contact lens design can be used to determine the lens powers, surface radii, center thickness, and the other parameters required to complete the design of the multi-focal contact lens optic described above.

In the preferred embodiment, the contact lens is made of a soft material such as silicone hydrogel and has the diameter of a semi-scleral contact lens which is in the range of 13.5 to 16 mm. Other materials or even a hard lens are alternatives to the preferred embodiment and other lens diameters are possible.

As a result, the contact lens for correcting an eye of a presbyopic patient has an optic body sized and configured to be received in an eye of a presbyopic patient. The optic body includes a front surface with a front optical center and a back surface with a back optical center, and having a lens optical axis intersecting the front surface at the front optical center and the back surface at the back optical center, and having optical zones which are not symmetric about the lens optical axis, wherein said lens construction produces an asymmetric point spread function which enables any resulting asymmetric stray light to be steered in a predetermined direction.

Similarily, a pair of contact lenses for treatment of the eyes of a presbyopic patient have a pair of contact lenses including a left eye lens and a right eye lens, each lens having an optic body sized and configured to be received, respectively, in a left or right eye of a presbyopic patient. Each lens having an optic body including a front surface with a front optical center and a back surface with a back optical center, and having a lens optical axis intersecting the front surface at the front optical center and the back surface at the back optical center, and having optical zones which are not symmetric about the lens optical axis, wherein each said lens construction produces an asymmetric point spread function which enables any resulting asymmetric stray light to be steered in a direction opposite to that of the other member of said pair of lenses; whereby stray light aberrations are canceled or reduced as a result of the patient's higher vision processing, thereby providing improved vision over traditional multi-focal concentric zone corrections.

For various optical designs above, the orientation and design of the regions in total should produce an asymmetric point spread function at a focal plane so that if rotated (or reflected) the resulting image due to stray light from two such contact lenses in the left and right eyes would tend to cancel.

In addition to the aforementioned embodiments, the following extensions are further contemplated:

1. More than two discrete or blended radial focal zones could be used to provide additional focal regions for the contact lens.

2. The astigmatic power and focal zones could be incorporated into both surfaces either equally or by some fraction between the two surfaces.

3. An aspheric back surface or zones could be utilized to reduce aberrations of the lens

4. The design of the optic could be such that a nonsymmetric point spread function could be produced by other means such as a diffractive optic or an optic created by altering the profile of the refractive index inside the optic.

5. The same bi-focal optical principles can be applied to the design of intraocular lenses, corneal refractive surgery plans, or corneal implants.

It is to be understood that while a certain form of the invention is illustrated, it is not to be limited to the specific form or arrangement herein described and shown. It will be apparent to those skilled in the art that various changes may be made without departing from the scope of the inventions and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

1. A contact lens for correcting an eye of a presbyopic patient comprising: an optic body sized and configured to be received in an eye of a presbyopic patient, said optic body including a front surface with a front optical center and a back surface with a back optical center, and having a lens optical axis intersecting the front surface at the front optical center and the back surface at the back optical center, and having optical zones which are not symmetric about the lens optical axis, wherein said lens construction produces an asymmetric point spread function which enables any resulting asymmetric stray light to be steered in a predetermined direction.

2. The contact lens of claim 1 wherein said lens is optimized for physiological conditions including pupil diameter and visual preferences; thereby providing for desired distance clarity versus near clarity for a specific individual's eye.

3. The contact lens of claim 1 further including an astigmatic correction.

4. The contact lens of claim 1 wherein one surface of said lens includes a plurality of individual regions, each individual region having a distinct or blended optical power, and being constructed and arranged aspherically to reduce overall aberrations; whereby said lens is optimized based upon patient preference for near, middle, or distance clarity.

5. The contact lens of claim 4 further including an astigmatic correction.

6. The contact lens of claim 4 wherein said individual regions are partitioned as radial sections.

7. The contact lens of claim 4 wherein said individual regions are partitioned as polygonal sections, radial sections, or a combination thereof.

8. The contact lens of claim 4 wherein the astigmatic correction and individual optical power regions are incorporated into both the front and back surfaces either equally or by some fraction between the two surfaces.

9. The contact lens of claim 1 wherein a nonsymmetric point spread function is produced by means of a diffractive optic, or an optic created by altering the profile of refractive index inside the optic.

10. A pair of contact lenses for treatment of the eyes of a presbyopic patient comprising: a pair of contact lenses including a left eye lens and a right eye lens, each lens having an optic body sized and configured to be received, respectively, in a left or right eye of a presbyopic patient, each said lens having an optic body including a front surface with a front optical center and a back surface with a back optical center, and having a lens optical axis intersecting the front surface at the front optical center and the back surface at the back optical center, and having optical zones which are not symmetric about the lens optical axis, wherein each said lens construction produces an asymmetric point spread function which enables any resulting asymmetric stray light to be steered in a direction opposite to that of the other member of said pair of lenses; whereby stray light aberrations are canceled or reduced as a result of the patient's higher vision processing, thereby providing improved vision over traditional multi-focal concentric zone corrections.

11. The contact lenses of claim 10 wherein each said lens is optimized for physiological conditions including pupil diameter and visual preferences; thereby providing for desired distance clarity verses near clarity for a specific individual's eyes.

12. The contact lenses of claim 10 further including an astigmatic correction.

13. The contact lenses of claim 10 wherein one surface of each said lens includes a plurality of individual regions, each individual region having a distinct or blended optical power, and being constructed and arranged aspherically to reduce overall aberrations; whereby each said lens is optimized based upon patient preference for near, middle, or distance clarity.

14. The contact lens of claim 13 further including an astigmatic correction.

15. The contact lens of claim 13 wherein said individual regions are partitioned as radial sections.

16. The contact lenses of claim 13 wherein each said lenses individual regions are partitioned as polygonal sections, radial sections, or a combination thereof.

17. The contact lenses of claim 13 wherein the astigmatic correction and individual optical power regions of each lens are incorporated into both the front and back surfaces either equally or by some fraction between the two surfaces.

18. The contact lenses of claim 10 wherein a nonsymmetric point spread function is produced, in at least one of said lenses, by means of a diffractive optic, or an optic created by altering the profile of refractive index inside the optic.
